(19) United States
(12) Patent Application Publication
(10) Pub. No.: US 2003/0184494 A1
(43) Pub. Date: Oct. 2, 2003

(54) Antenna switch and portable apparatus

(76) Inventor: Kosuke Yagi, Hyogo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,972

(22) PCT Filed: Jul. 30, 2001
(86) PCT No.: PCT/JP01/06557

(51) Int. Cl. H01Q 3/24; H01Q 1/24

(52) U.S. Cl. 343/876; 343/702

(57) ABSTRACT

An antenna switching device (4) is an antenna switching device (4) for switching between a first antenna (2) and a second antenna (3) and includes a base member (9), a moving member (10) having a portion capable of contacting a portion of the first antenna (2), the moving member (10) moving linearly relative to the base member (9) as the first antenna (2) moves, and a biasing member (11, 21, 25, 28) biasing the moving member (10) toward the portion of the first antenna (2).

### TECHNICAL FIELD

The present invention relates generally to antenna switching devices and mobile equipment and particularly to antenna switching devices for use in mobile phones and mobile personal computers, personal digital assistants (PDAs) or any other similar mobile equipment having a plurality of antennas, and mobile equipment using the antenna switching device.

### BACKGROUND ART

In recent years, mobile phones, mobile personal computers, PDAs or other similar mobile equipment are rapidly have widely been used. Such mobile equipment that has a communication function is provided with an antenna transmitting and receiving electric waves for communications. To obtain high quality of communications depending on the mobile equipment's arrangement and environment, the mobile equipment may be provided with a plurality of antennas. Such mobile equipment having a plurality of antennas is provided with an antenna switching device switching between the multiple antennas for use in communication.

One such antenna switching device is conventionally known, as disclosed for example in Japanese Utility Model Laying-Open No. 1-91348. The publication discloses an antenna switching device switching between an external, pull-out linear antenna and an internal antenna arranged internal to the casing of mobile equipment (a radio set). As disclosed in the publication, the antenna switching device includes a rotary cam member rotating as the external linear antenna is pulled out/pushed in. As the rotary cam member is rotated, one end of a rotor connected to the cam member presses and releases an actuator of a switch. Thus when the external linear antenna is pulled out/pushed in the switch can be turned on/off so that the external linear antenna and the internal antenna can be switched for use.

Furthermore, another conventional, proposed antenna switching device includes: a base having an opening receiving and passing an external linear antenna therethrough; a sliding cam provided in the base and assuming different positions when the external linear antenna has a portion present in and absent from, respectively, the opening; a rotative cam connected to the sliding cam to rotate as the sliding cam operates; a screw securing the rotative cam and also serving as an axis of rotation; a washer used in securing the screw; and a spring applying a stress to the rotative cam in a direction. In the above, another antenna switching device the sliding cam can positionally vary as the external linear antenna is pulled out/pushed in, and as the sliding cam can positionally vary, the rotative cam can rotate to turn a switch on/off, similarly as achieved by the technique disclosed in Japanese Utility Model Laying-Open No. 1-91348. As the switch can be turned on/off, the external linear antenna and the internal antenna can be switched for use.

As disclosed in Japanese Utility Model Laying-Open No. 1-91348, however, the antenna switching device requires a large number of components including a cam member, a rotor, a screw positionally securing them and also serving as a center of rotation, and a coiled spring applying a stress to the cam member, the rotor and the like in a direction, as has been described above. Furthermore, the aforementioned, another conventional antenna switching device also requires a large number of components such as a base, a sliding cam, a rotative cam, a screw, a washer and a spring. As the antenna switching device is comprised of such a large number of components, to allow the antenna switching device to have a mechanism of a precision (e.g., dimension precision) maintained at a predetermined level each component needs to be dimensioned with high precision. Accordingly, the component is designed with a relatively small margin. This makes it difficult to design the antenna switching device.

Furthermore, the aforementioned conventional antenna switching device is also relatively complicated in structure. As such, it is cumbersome and time-consuming to assemble such an antenna switching device as described above. This increases the cost for producing mobile equipment employing this antenna switching device.

The present invention has been made to overcome such disadvantages as described above and it contemplates an antenna switching device having a mechanism of high precision and also produced at reduced cost, and mobile equipment using the antenna switching device.

### DISCLOSURE OF THE INVENTION

The present invention in one aspect provides an antenna switching device switching between a first antenna and a second antenna, including: a base member; a moving member having a portion capable of contacting a portion of the first antenna, the moving member moving linearly relative to the base member as the first antenna moves; and a biasing member biasing the moving member toward the portion of the first antenna.

Thus the biasing member can maintain the moving member in contact with a surface of a portion of the first antenna, and as the first antenna moves, the moving member linearly moves, so that arranging a detector detecting the moving member's position in a direction of the movement of the moving member can help to detect the first antenna's movement (i.e., the first antenna's position relative to the base member) from the moving member's position. The detector's output can be used to switch between the first and second antennas for use depending on the situation of interest.

Furthermore, since the moving member linearly moves, as has been described above, for example holding the moving member on a linear path formed internal to the base member allows the antenna switching device to be implemented by the three elements of the aforementioned base, moving and biasing members. More specifically, if a rotative cam or the like is used, as conventional, a screw or the like is required for securing the rotative cam, whereas the present antenna switching device can dispense with such a screw and thus have a simplified configuration. As such, the present antenna switching device can be comprised of a reduced number of components and its material's cost can thus be reduced. Furthermore the reduced number of components allows individual components to be designed with a margin larger than conventional if the antenna switching device has a mechanism with the same precision as conventional. Furthermore, if individual components are designed with the same margin as conventional, the antenna switching device can have a mechanism with higher precision than conventional.

Furthermore, the antenna switching device simplified in configuration, as described above, can be produced by a simplified process. In other words, the antenna switching device can be produced in a reduced period of time and hence at reduced cost.

Furthermore, the antenna switching device having such a simple configuration can be readily miniaturized. As such, the antenna switching device can be arranged in a reduced area (or volume). Furthermore, the antenna switching device can also be reduced in weight. As such, if this antenna switching device is applied to mobile equipment which is miniaturized, the antenna switching device does not prevent the mobile equipment from being miniaturized.

In the above one aspect the antenna switching device may include switching means switching between the first antenna and the second antenna for use as the first antenna moves.

The antenna switching device that itself includes switching means can be applied to mobile equipment having a simpler configuration than when a detector or the like detecting the moving member's position is arranged as a separate member. As such, the mobile equipment with the present antenna switching device applied thereto can be manufactured at reduced cost.

In the above one aspect, in the antenna switching device the switching means may include a detection member detecting a position of the moving member relative to the base member.

Depending on the position of the moving member that is detected by the detection member, the first and second antennas can be readily switched for use.

In the above one aspect, in the antenna switching device the detection member may be formed integral with the moving member.

The antenna switching device thus configured can be simpler and smaller in configuration than when the detection member is arranged as a member independent from the moving member.

In the above one aspect, in the antenna switching device the first antenna may be a linear antenna capable of being pulled out from the base member and when the first antenna is not pulled out the biasing member may bias and bring the moving member into contact with a portion of the first antenna and when the first antenna is pulled out the biasing member may bias and move the moving member away from the position of the moving member having contact with the portion of the first antenna.

When the first linear antenna is pulled out the biasing member ensures that the moving member has a position and when the first antenna is not pulled out (or it is accommodated) the biasing member ensures that the moving member has a different position. As such, detecting the moving member's position ensures detection of variation between the pulled out position and accommodated position of the first antenna. Consequently, depending on the first antenna's position, which of the first and second antenna to be used can be readily changed.

In the above one aspect, in the antenna switching device the biasing member may include a coiled spring.

A coiled spring is relatively readily available and inexpensive. This can prevent the antenna switching device's production cost from increasing.

In the above one aspect, in the antenna switching device the biasing member may include a plate spring.

A plate spring has a relatively simple geometry. As such, it can be formed of dielectric such as elastic resin. If the biasing member is a spring of metal, it may adversely affect the antenna's characteristics, since metal is a conductor. Using the biasing member in the form of the plate spring formed of dielectric such as resin, as described above, can prevent the biasing member from adversely affecting the antenna's characteristics.

In the above one aspect, in the antenna switching device the moving member and the plate spring may integrally be formed.

The moving member and the plate spring serving as the biasing member that are integrally formed allow the antenna switching device to be formed of a further reduced number of components. As such, the antenna switching device can have a further simplified configuration.

In the above one aspect, in the antenna switching device the base member and the plate spring may integrally be formed.

The base member and the plate spring serving as the biasing member that are integrally formed allow the antenna switching device to be formed of a further reduced number of components. As such, the antenna switching device can have a further simplified configuration.

The present invention in another aspect provides an antenna switching device for switching between the first and second antennas, including: an opening and closing member arranged to be capable of contacting a portion of the first antenna and switching between open and closed positions as the first antenna moves; and a detection member detecting the open and closed positions of the opening and closing member.

The opening and closing member's position can be detected by the detection member to help to detect the first antenna's movement (or position). The detection member's output can be used to switch between the first and second antennas for use.

Furthermore, using the two members of the opening and closing member and the detection member to configure an antenna switching member allows the device to have a simpler configuration than conventional. As such in accordance with the present invention in the above another aspect the antenna switching device can be formed of a reduced number of components and its material's cost can thus be reduced. Furthermore the reduced number of components allows individual components to be designed with a margin larger than conventional if the antenna switching device has a mechanism with the same precision as conventional. Furthermore, if individual components are designed with the same margin as conventional, the antenna switching device can have a mechanism with higher precision than conventional.

Furthermore, the antenna switching device simplified in configuration, as described above, can be produced by a simplified process. In other words, the antenna switching device can be produced in a reduced period of time and hence at reduced cost.

Furthermore, the antenna switching device having such a simple configuration can be readily miniaturized. As such, the antenna switching device can be arranged in a reduced area (or volume). Furthermore, the antenna switching device can also be reduced in weight. As such, if this antenna switching device is applied to mobile equipment which is miniaturized, the antenna switching device does not prevent the mobile equipment from being miniaturized.

In the antenna switching device in the above another aspect the first antenna has a portion contacting the opening and closing member that may be provided with a protrusion for pressing the opening and closing member.

When the first antenna reaches a position allowing the antenna to contact the opening and closing member, the antenna's protrusion presses the opening and closing member to ensure that the opening and closing member is closed. As such, erroneous detection of the first antenna's position can be prevented.

The present invention in still another aspect provides mobile equipment being mobile equipment having a plurality of antennas and including the antenna switching device in the above one or another aspect.

Thus the present invention can provide antenna switching device having a simplified configuration and thus smaller in size and weight than conventional to implement mobile equipment smaller in size and weight than conventional. Furthermore, the antenna switching device can also be formed of a smaller number of components than conventional so that the device's material cost can be reduced and the device can also be produced by a simplified process. As a result, the mobile equipment can be produced at reduced cost.

### BRIEF DESCRIPTION OF THE DRAWINGS

In the drawings:

FIG. 1 schematically shows a first embodiment of a mobile phone of the present invention;

FIG. 2 schematically illustrates how a switching member is arranged in the FIG. 1 mobile phone;

FIG. 3 is a schematic cross section of FIG. 2 taken along a line III-III;

FIG. 4 is a schematic, perspective view of the switching member;

FIG. 5 is an exploded, perspective, schematic view of the switching member shown in FIG. 4;

FIG. 6 is a partially enlarged, schematic cross section of the FIG. 1 mobile phone;

FIG. 7 is a schematic cross section of FIG. 6 taken along a line VII-VII;

FIG. 8 is a partially enlarged, schematic cross section of the FIG. 1 mobile phone;

FIG. 9 is a schematic cross section of FIG. 8 taken along a line IX-IX;

FIG. 10 is a schematic, perspective view of a switching member used in a second embodiment of the mobile phone of the present invention;

FIG. 11 is an exploded, perspective, schematic view of the switching member shown in FIG. 10;

FIG. 12 is a schematic, perspective view for illustrating an exemplary variation of the switching member shown in FIGS. 10 and 11;

FIG. 13 is a schematic, perspective view for illustrating a sliding cam of a switching member used in a third embodiment of the mobile phone of the present invention;

FIG. 14 is a partially enlarged, schematic cross section for illustrating an operation of the switching member in the third embodiment of the mobile phone of the present invention;

FIG. 15 is a schematic cross section of FIG. 14 taken along a line XV-XV;

FIG. 16 is a partially enlarged, schematic cross section for illustrating an operation of the switching member in the third embodiment of the mobile phone of the present invention;

FIG. 17 is a schematic cross section of FIG. 16 taken along a line XVII-XVII;

FIG. 18 is a partially enlarged, schematic cross section of an exemplary variation of the third embodiment of the mobile phone of the present invention;

FIG. 19 is a schematic cross section of FIG. 18 taken along a line XIX-XIX;

FIG. 20 is another partially enlarged, schematic cross section for illustrating the exemplary variation of the third embodiment of the mobile phone of the present invention;

FIG. 21 is a schematic cross section of FIG. 20 taken along a line XXI-XXI;

FIG. 22 is a schematic view for illustrating a fourth embodiment of the mobile phone of the present invention; and

FIG. 23 is a schematic view for illustrating the fourth embodiment of the mobile phone of the present invention.

### BEST MODES FOR CARRYING OUT THE INVENTION

Hereinafter, best modes for carrying out the invention will be described with reference to the drawings. In the figures, like components are denoted by like reference characters and their descriptions will not be repeated.

First Embodiment

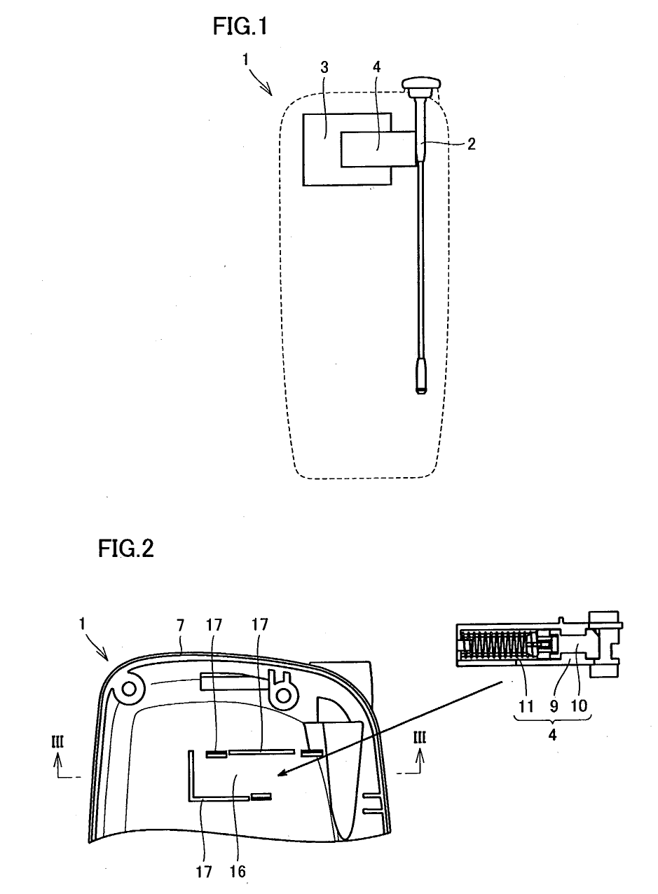

With reference to FIG. 1, a mobile phone 1 includes an internal antenna 3 arranged internal to mobile phone 1, a linear antenna 2 capable of being pulled out external to the casing of mobile phone 1, and a switching member 4 serving as an antenna switching device for switching between antennas 2 and 3 for use. Although not shown in the figure, mobile phone 1 is provided with a crystal liquid display for displaying telephone numbers or any other similar information in characters, images and the like, a speaker, a microphone, a button used to input telephone numbers, characters and the like, and the like.

With reference to FIGS. 2-5, in the present invention mobile phone 1 is provided with switching member 4 structured and arranged, as will be described hereinafter.

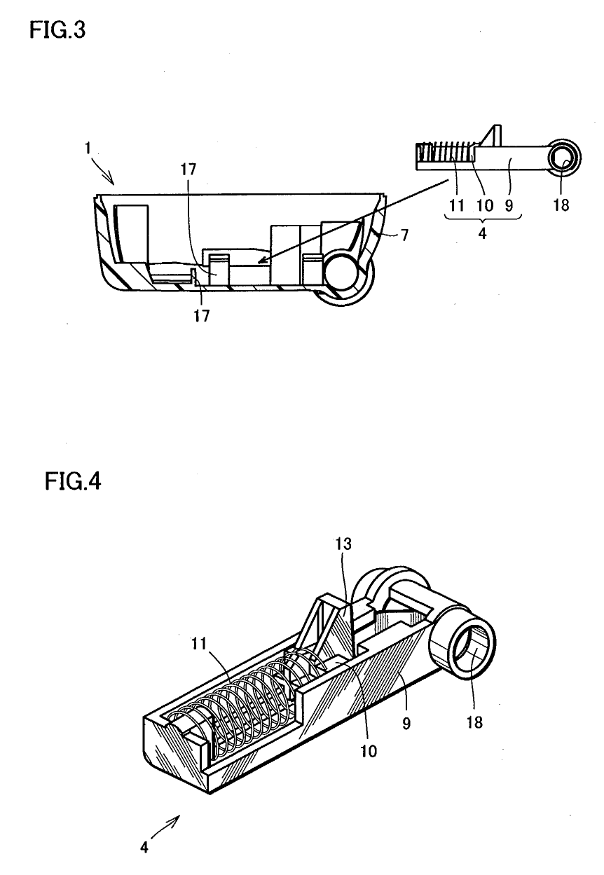

With reference to FIGS. 2 and 3, switching member 4 is secured to a rear case 7 forming the casing of mobile phone 1. Rear case 7 has an inner surface provided with a surrounding wall 17 for securing switching member 4, surrounding a location 16 of a region in which switching member 4 is arranged. As can be understood from FIGS. 4 and 5, switching member 4 is formed by a spring 11 serving as a biasing member, a base serving as a base member, and a sliding cam 10 serving as a moving member. Sliding cam 10 is provided with a protrusion 13. Note that base 9 and sliding cam 10 are formed of dielectric such as lubricant resin. Spring 11 is formed of metal.

Sliding cam 10 is arranged internal to a linear path formed in base 9. Arranged in base 9, sliding cam 10 has protrusion 13 protruding external to base 9. Sliding cam 10 is linearly slidable in base 9. A coiled spring 11 is arranged between an end 20 provided on base 9 at an internal side and an end 19 of sliding cam 10. Coiled spring 11 is formed of metal and it is relatively readily available and inexpensive. Spring 11 allows sliding cam 10 to be pressed in base member 9 toward a hole 18 provided to receive and pass pull-out antenna 2.

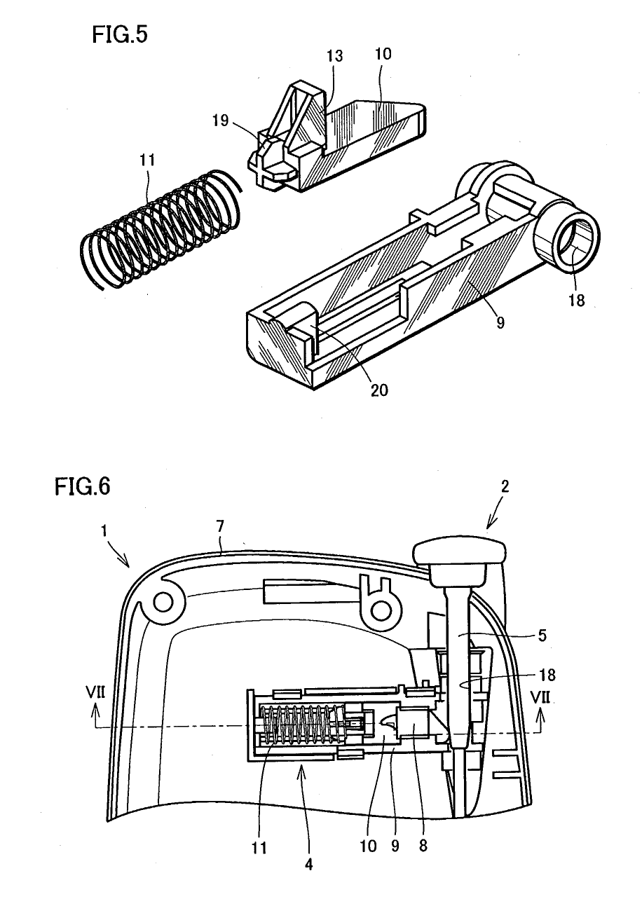

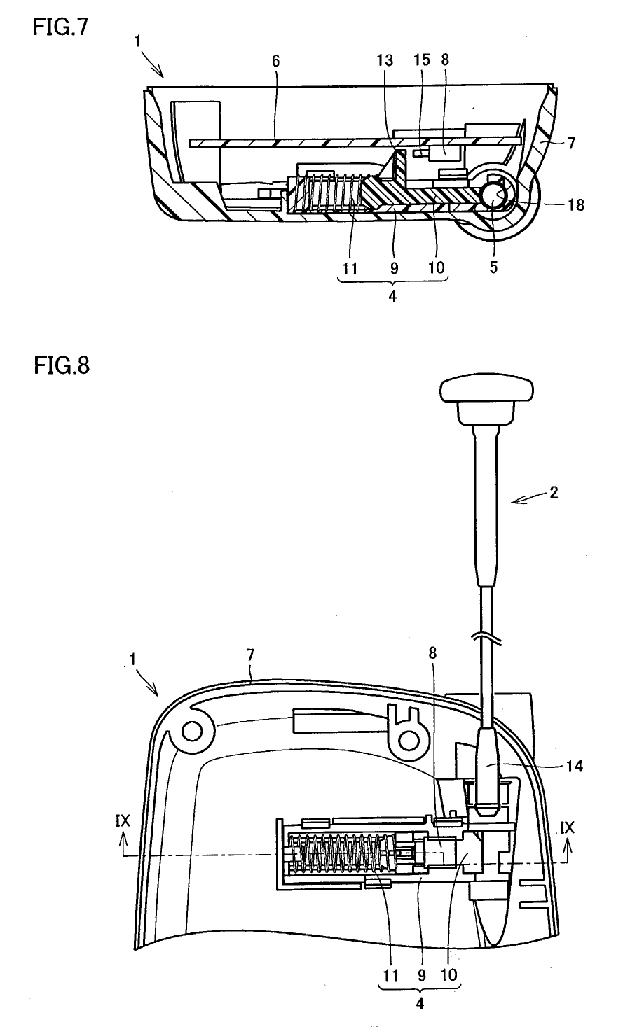

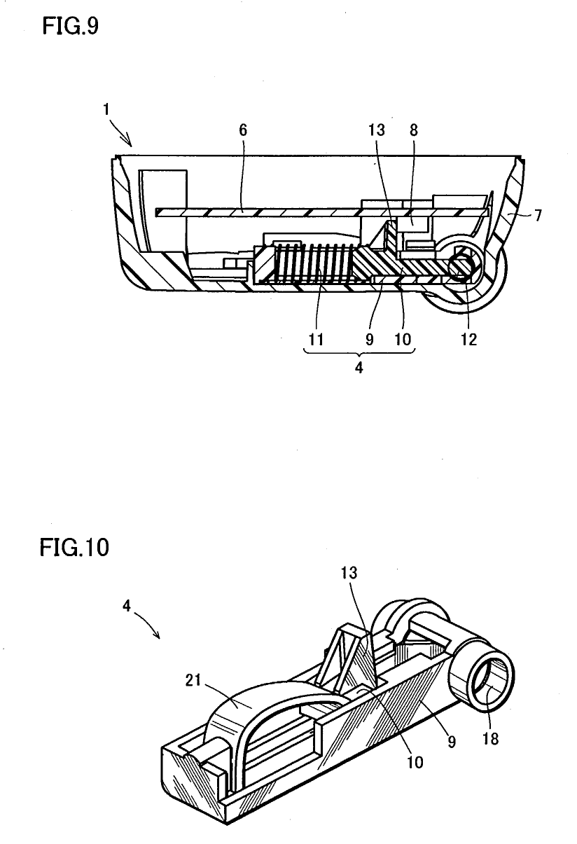

Reference will now be made to FIGS. 6-9 to describe how in the FIG. 1 mobile phone 1 switching member 4 operates. FIGS. 6 and 7 show that mobile phone 1 has antenna 2 accommodated internal to the phone's casing. FIGS. 8 and 9 show that the FIG. 1 mobile phone 1 has antenna 2 pulled out of the phone's casing.

With reference to FIGS. 6 and 7, when mobile phone 1 has antenna accommodated internal to the phone's casing, antenna 2 has an upper portion 5 having a surface in contact with one end of sliding cam 10 configuring switching member 4. More specifically, antenna 2 is arranged through hole 18 of base 9 of switching member 4, and antenna 2 has upper portion 5 partially positioned in hole 18. In switching member 4, spring 11 presses sliding cam 10 toward hole 18. As such, sliding cam 10 has one end brought into contact with a surface of upper portion 5 of antenna 2, and, as can also be seen from FIG. 7, sliding cam 10 also has protrusion 13 facing and spaced from a switching protrusion 15 of a switch 8. Switch 8 is arranged on a printed circuit board 6 of mobile phone 1.

Then, with reference to FIGS. 8 and 9, when antenna 2 is pulled out of the casing of mobile phone 1, antenna 2 has a lower end 14 moving past hole 18 and thus positioned above base 9. In other words, hole 18 does not hold the antenna's lower end 14. As such, sliding cam 10 does not contact antenna 2 and it is pressed by the biasing spring 11 toward hole 18 and thus has one end having entered hole 18. In other words, sliding cam 10 has been moved toward hole 18 by the diameter of antenna 2, and sliding cam 10 has protrusion 13 contacting switching protrusion 15 of switch 8 to push protrusion 15 into switch 8.

In other words, when mobile phone 1 has antenna 2 accommodated in the phone's casing, protrusion 15 is not pressed by protrusion 13 (protrusions 15 and 13 face and are spaced from each other). When mobile phone 1 has antenna 2 pulled out of the phone's casing, protrusion 15 is pressed by protrusion 13.

Accordingly, whether antenna 2 is accommodated in or pulled out of the casing can be detected from whether protrusion 15 has been pressed. Consequently, whether protrusion 15 has been pressed or not can be depended on to control mobile phone 1 to switch between antenna 2 and internal antenna 3.

As has been described above, in accordance with the present invention, switching member 4 can have a relatively simple structure formed by the three members of base 9, sliding cam 10 and spring 11. As such, switch member 4 can have a mechanism better in precision and better assembleability than a complicated switching member as conventional. Furthermore, switching member 4 can be formed of a smaller number of components than conventional. As such, if it's mechanism is to have the same precision as conventional, its individual components (base 9, sliding cam 10 and the like) can be designed with a margin larger than conventional. Furthermore, such a simple structure allows switching member 4 to be produced by a simplified process and hence at reduced cost.

Furthermore, switching member 4 thus having a simple structure can be readily miniaturized. As such, switching member 4 can occupy a reduced volume or area mobile phone 1.

Furthermore, base 9 and sliding cam 10 serving as components of switching member 4 can be formed of resin, as has been described above. As such, switching member 4 can have a smaller weight than a complicated switching member for example using a screw of metal as conventional.

Second Embodiment

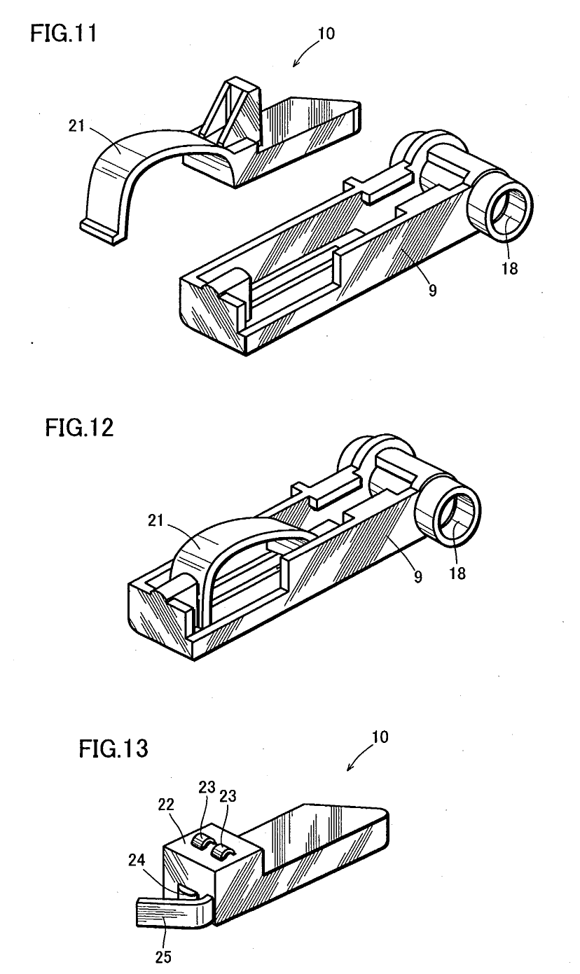

Reference will now be made to FIGS. 10 and 11 to describe a switching member used in a second embodiment of the mobile phone of the present invention.

With reference to FIGS. 10 and 11, switching member 4 is basically similar in structure to that used in the first embodiment of the present invention, although as a biasing member a plate spring 21 is used, rather than a coiled spring. Plate spring 21 is formed of elastic resin and it is formed integral with sliding cam 10. In other words, switching member 4 is configured of sliding cam 10 formed integral with plate spring 21, and base 9, all formed of dielectric resin.

Switching member 4 thus configured can be as effective as that used in the mobile phone of the first embodiment and it can also have as simple a structure as formed by the two members of sliding cam 10 formed integral with plate spring 21, and base 9. As such, switching member 4 can be assembled by a simplified process and thus produced at reduced cost.

Furthermore, switching member 4 can entirely be formed of dielectric resin. As such, the existence of switching member 4 does not adversely affect characteristics of antenna 2. (If in a vicinity of antenna 2 there exists spring 11 of metal, as described in the first embodiment, the existence of metal spring 11 may adversely affect characteristics of antenna 2. Switching member 4 as shown in FIGS. 10 and 11 does not have such a negative effect.) Consequently, antenna 2 can have satisfactorily maintained characteristics. This ensures a sufficient margin with respect to characteristics in designing mobile phone 1 as a product.

Furthermore, switching member 4 formed of a reduced number of components, as described above, can help to reduce the cost of the mobile phone.

FIG. 12 shows base 9 used in an exemplary variation of the switching member. With reference to FIG. 12, plate spring 21 of resin is formed integral with base 9 of resin. By providing base 9 of FIG. 12 with sliding cam 10 of FIG. 5, a switching member similar in function to that shown in FIGS. 10 and 11 can be implemented.

Switching member 4 in this example can also be formed by the two members of base 9 with plate spring 21 integrated therewith and sliding cam 10. The switching member thus obtained can be as effective as that shown in FIGS. 10 and 11.

Third Embodiment

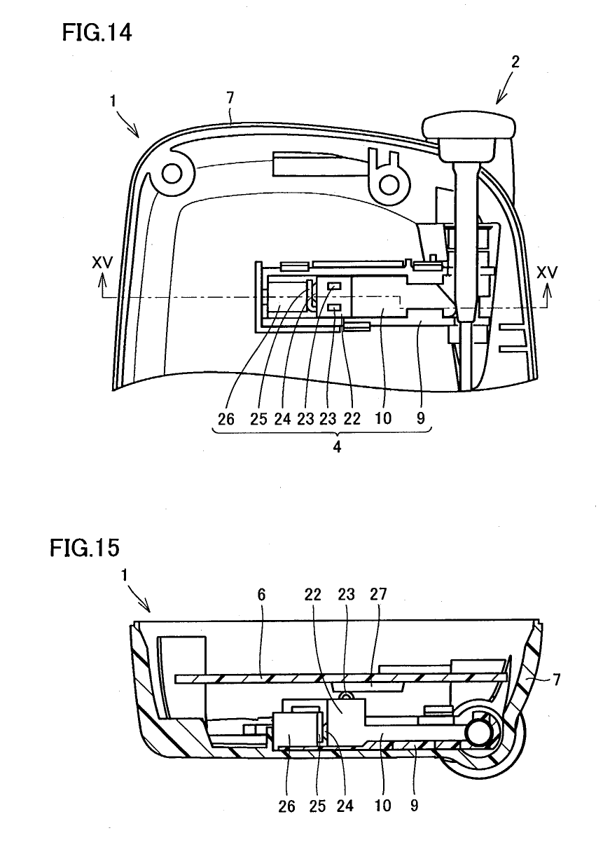

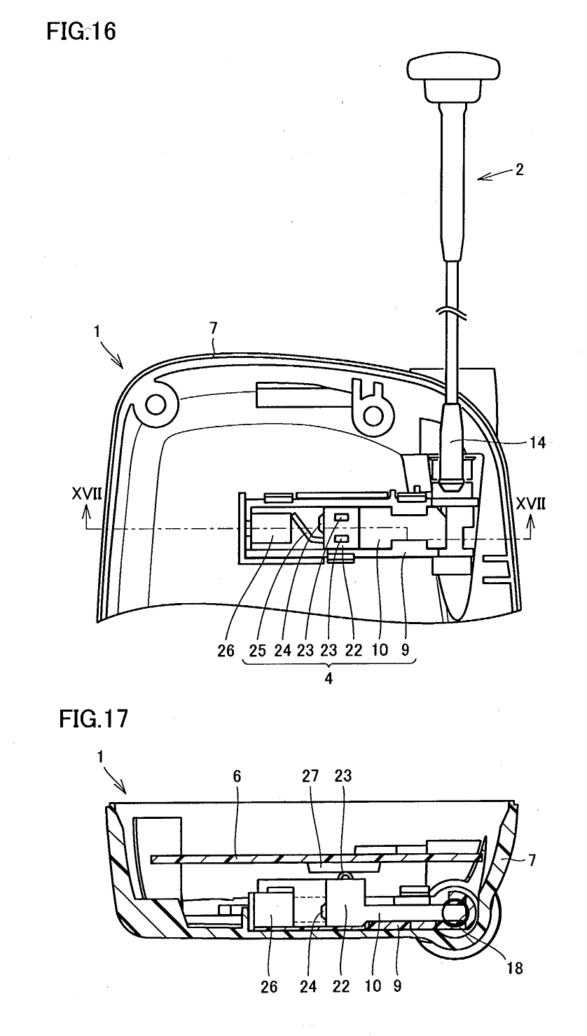

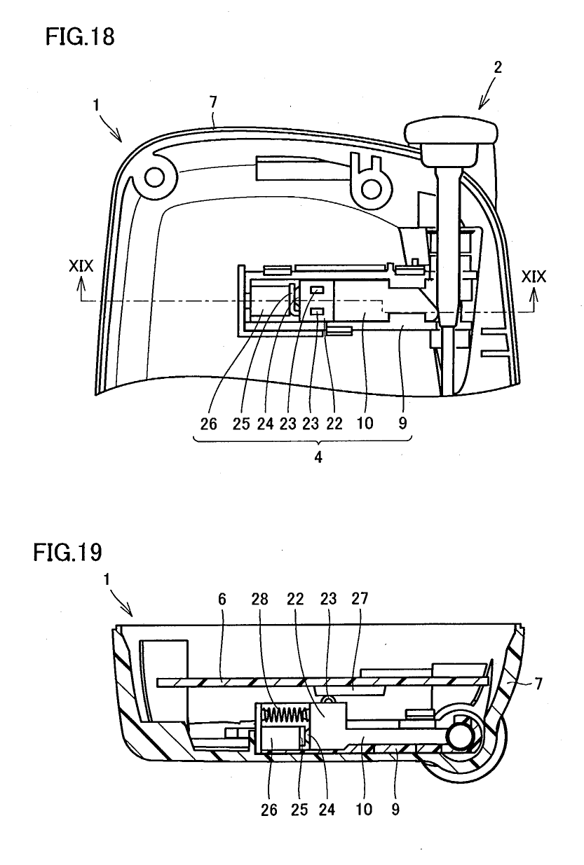

Reference will now be made to FIGS. 14-17 to describe a third embodiment of the mobile phone of the present invention. FIGS. 14, 15, 16 and 17 correspond to FIGS. 6, 7, 8 and 9, respectively. In FIGS. 14 and 15, mobile phone 1 has antenna 2 accommodated in the phone's casing. In FIGS. 16 and 17, mobile phone 1 has antenna 2 pulled out of the phone's casing.

With reference to FIG. 13, the present mobile phone in the third embodiment uses a switching member with sliding cam 10 including a plate spring 25, a detection switch 24 and a terminal 23, which configure a switching means. Terminal 23 is provided on an upper surface of a protrusion 22 of sliding cam 10. Detection switch 24 and plate spring 25 are provided on a sidewall surface of sliding cam 10.

Reference will now be made to FIGS. 14-17 to describe an operation of the switching member in the third embodiment of the mobile phone of the present invention.

As shown in FIGS. 14 and 15, when mobile phone 1 has antenna 2 accommodated in the phone's casing, antenna 2 has an upper portion having a surface in contact with one end of sliding cam 10, as has been described with reference to FIGS. 6 and 7. Note that for switching member 4 shown in FIGS. 14-17, base 9 receives the FIG. 13 sliding cam 10 and a spacer 26. Note that although herein spacer 26 is used to utilize base 9 of the first embodiment, spacer 26 can be dispensed with if base 9 has a length reduced by that of spacer 26.

Then, as shown in FIGS. 14 and 15, sliding cam 10 that has one end in contact with the antenna's upper surface has a position close to spacer 26. Accordingly, plate spring 25 is pressed by spacer 26 (or base 9 if the base is previously reduced in length by that of spacer 26) and thus brought into contact with detection switch 24, and a signal corresponding to plate spring 25 being brought into contact with detection switch 24 is transmitted through terminal 23 to a printed circuit board terminal 27 provided on a surface of printed circuit board 6 and arranged in contact with terminal 23 of sliding cam 10.

Then, as shown in FIGS. 16 and 17, when antenna 2 is pulled out of the casing of mobile phone 1, antenna 2 no longer has lower end 14 in hole 18 of base 9 of switching member 4, as described with reference to FIGS. 8 and 9. As such, the elasticity of plate spring 25 forces sliding cam 10 to move toward hole 18. As a result, as shown in FIGS. 16 and 17, detection switch 24 and plate spring 25 face and are spaced from each other, and a signal corresponding to plate spring 25 being out of contact with detection switch 24 is transmitted through terminal 23 to terminal 27. (Note that alternatively no signal may be transmitted through terminal 23 to terminal 27.)

When antenna 2 is accommodated in the casing of mobile phone 1, plate spring 25 contacts detection switch 24. When antenna 2 is pulled out of the casing of mobile phone 1, plate spring 25 is out of contact with detection switch 24. An electrical signal indicating whether plate spring 25 is in contact with detection switch 24 can be transmitted from terminal 23 of sliding cam 10 through substrate terminal 27 to a control circuit, which is formed on printed circuit board 6, to help to detect whether antenna 2 has been pulled out of or accommodated in the phone's casing, and the position of antenna 2 can be depended on to switch between using internal antenna 3 arranged internal to mobile phone 1 and using pull-out antenna 2 for communication. For example, if antenna 2 is pulled out of the casing of mobile phone 1, as shown in FIGS. 16 and 17, antenna 2 can be used for communication, and if antenna 2 is accommodated in the casing of mobile phone 1, as shown in FIGS. 14 and 15, internal antenna 3 can be used for communication.

Thus switching member 4 itself includes plate spring 25, detection switch serving as a detection member, and terminal 23 that serve as a switching means. As such, switching member 4 can be applied to mobile phone 1 having a simpler device configuration than when for example switch 8 serving as a detector detecting the position of sliding cam 10 serving as a moving member is provided as a separate member. As such, mobile phone 1 can be produced at reduced cost.

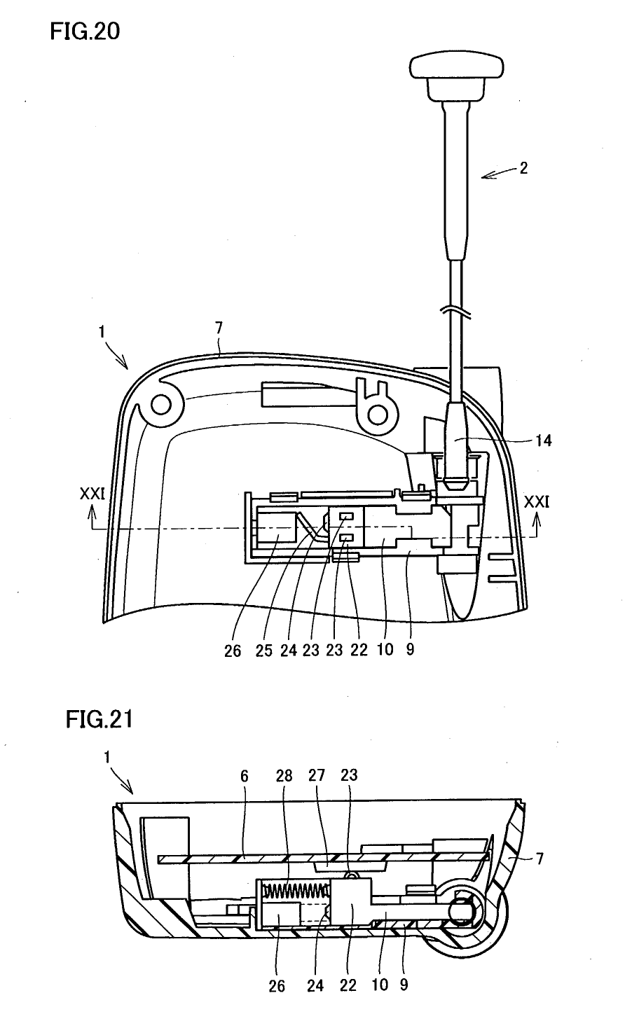

Reference will now be made to FIGS. 18-21 to describe a variation of the third embodiment of the present mobile phone. FIGS. 18, 19, 20 and 21 correspond to FIGS. 14, 15, 16 and 17, respectively. In FIGS. 18 and 19, the present mobile phone in the third embodiment as modified by way of example has antenna 2 accommodated in the casing of mobile phone 1. In FIGS. 20 and 21, the present mobile phone in the third embodiment as modified by way of example has antenna 2 pulled out of the phone's casing.

With reference to FIGS. 18-21, the mobile phone is basically similar in configuration to that of the third embodiment as shown in FIGS. 13-17, except that switching member 4 is configured differently. More specifically, the FIGS. 18-21 mobile phone 1 employs switching member 4 with a coiled spring 28 added thereto to ensure that sliding cam 10 is more firmly pressed toward hole 18. This ensures that sliding cam 10 has an end brought into close contact with a surface of antenna 2.

The mobile phone shown in FIGS. 18-21 can also be as effective as that shown in FIGS. 13-17. More specifically, since sliding cam 10 is provided with detection switch 24 and plate spring 24, the number of components required to switch between the internal antenna and pull-out antenna 2 can be reduced. Consequently the mobile phone can be produced at reduced cost.

Furthermore, sliding cam 10 with a detection switch formed integral thereto can eliminate the necessity of arranging switch 8 at a position different from that of the sliding cam, as described in the first embodiment of the present mobile phone. This can in turn eliminate the necessity of ensuring a mounting space for arranging switch 8. As such, the mobile phone can further be miniaturized.

Fourth Embodiment

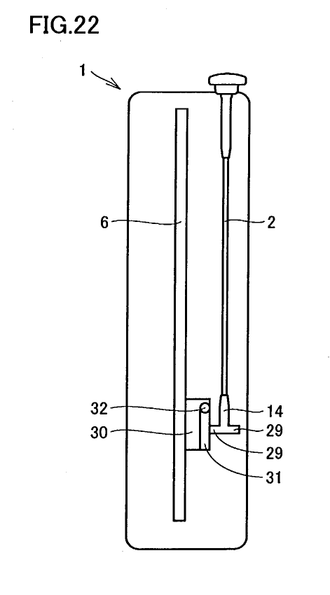

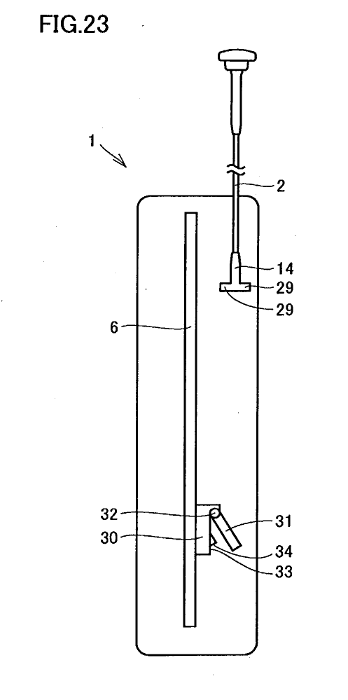

Reference will now be made to FIGS. 22 and 23 to describe a fourth embodiment of the mobile phone of the present invention. FIG. 22 shows that antenna 2 is accommodated in the casing of mobile phone 1 and FIG. 23 shows that antenna 2 is pulled out of the casing of mobile phone 1.

With reference to FIGS. 22 and 23, mobile phone 1 includes a printed circuit board 6 arranged internal to the casing, a switch 30 arranged on a surface of printed circuit board 6, a pull-out antenna 2, and an internal antenna (not shown). Mobile phone 1 also includes a liquid crystal display device, a speaker, a microphone, a button used to input characters, numbers and the like, and other features of typical mobile phones.

Switch 30 serving as an antenna switching device is provided with an opining and closing member 31 capable of assuming an open position and a closed position as it pivots around a shaft 32. Furthermore, antenna 2 has lower end 14 provided with a protrusion 29 capable of contacting member 31. When antenna 2 is accommodated in the casing of mobile phone 1, as shown in FIG. 22, protrusion 29 firmly presses member 31. As a result, member 31 presses a switching protrusion 34 formed on a surface 33 of switch 30 and serving as a detection member. When antenna 2 is pulled out of the casing of mobile phone 1, member 31 assumes the open position, pivoting around shaft 32. To allow member 31 to assume the open position, a coiled spring or the like may be incorporated in shaft 32. As a result, when antenna 2 is pulled out of the casing of mobile phone 1, as shown in FIG. 23, member 31 is out of contact with protrusion 34 of switch 30 (the protrusion is not pressed by member 31).

In other words, when antenna 2 is accommodated in the casing of mobile phone 1, switching protrusion 34 is pressed (ON). When antenna 2 is pulled out of the casing of mobile phone 1, protrusion 34 is not pressed or it is released (OFF). That is, switch 30 helps to detect whether antenna 2 has been pulled out of or accommodated in the casing of the mobile phone, and by transmitting a signal corresponding to the position of protrusion 34 to a control circuit formed on printed circuit board 6, using pull-out antenna 2 and using the internal antenna can be switched, as controlled to correspond to the position of antenna 2. For example, if antenna 2 is accommodated in the casing of mobile phone 1, as shown in FIG. 22, the internal antenna can be used for communication, and if antenna 2 is pulled out of the casing of mobile phone 1, as shown in FIG. 23, antenna 2 can be used for communication, as controlled.

Thus switch 30 structured relatively simply of opening and closing member 31 and switching protrusion 34 can be used to help to detect the position of antenna 2 (or whether it has been pulled out or accommodated). This allows the switching member to be formed of a smaller number of components than conventional and the mobile phone to be produced at reduced cost.

Furthermore, the switching member in the form of switch 30 can have a volume smaller than a switching member including a sliding cam and a base, as described in the first to third embodiments. Furthermore, switch 30 having a simple structure can be readily miniaturized. Consequently, mobile phone 1 can be reduced in size and weight.

Furthermore, the reduced number of components allows individual components (opening and closing member 31, switching protrusion 34 and the like) to enjoy a larger designing margin than conventional if switch 30 serving as an antenna switching device has a mechanism with the same precision as conventional. Furthermore, if individual components are designed with the same margin as conventional, switch 30 can have a mechanism with higher precision than conventional.

Furthermore, antenna 2 that is provided with protrusion 29 can firmly press opening and closing member 31 via protrusion 29. This can prevent erroneous detection via switch 30 of the position of antenna 2 serving as a first antenna.

Note that switching member 4, switch 30 and the like described in the first to fourth embodiments of the present invention are applicable not only to mobile phones shaped as shown in FIG. 1 but also those that can be flipped open and closed. Furthermore, the present invention is also applicable not only to mobile phones but electronics that can be used switching a plurality of antennas.

Industrial Applicability

In accordance with the present invention an antenna switching device is applicable to mobile phones or mobile personal computers, PDAs or any other similar electronics having a communication function, and furthermore typical radio sets.

1. An antenna switching device switching between a first antenna (2) and a second antenna (3), comprising:
a base member (9);
a moving member (10) having a portion capable of contacting a portion of said first antenna (2), said moving member (10) moving linearly relative to said base member (9) as said first antenna (2) moves; and
a biasing member (11, 21, 25, 28) biasing said moving member (10) toward the portion of said first antenna (2).

2. The antenna switching device according to claim 1, comprising switching means (8, 15) switching between said first antenna (2) and said second antenna (3) for use as said first antenna (2) moves.

3. The antenna switching device according to claim 2, wherein said switching means (8, 15, 24, 25, 23) includes a detection member (15) detecting a position of said moving member (10) relative to said base member (9).

4. The antenna switching device according to claim 3, wherein said detection member (24, 25, 23) is formed integral with said moving member (10).

5. The antenna switching device according to claim 1, wherein:
said first antenna (2) is a linear antenna (2) capable of being pulled out; and
when said first antenna (2) is not pulled out said biasing member (11, 21, 25, 28) biases and brings said moving member (10) into contact with the portion of said first antenna (2) and when said first antenna (2) is pulled out said biasing member (11, 21, 25, 28) biases and moves said moving member (10) away from the position of said moving member (10) having contact with the portion of said first antenna (2).

6. The antenna switching device according to claim 1, wherein said biasing member (11, 21, 25, 28) includes a coiled spring (11, 28).

7. The antenna switching device according to claim 1, wherein said biasing member (11, 21, 25, 28) includes a plate spring (21, 25).

8. The antenna switching device according to claim 7, wherein said moving member (10) and said plate spring (21, 25) are integrally formed.

9. The antenna switching device according to claim 7, wherein said base member (9) and said plate spring (21) are integrally formed.

10. Mobile equipment in a form of mobile equipment (1) having a plurality of antennas, comprising the antenna switching device (4) as recited in claim 1.

11. An antenna switching device (30) for switching between a first antenna (2) and a second antenna (3), comprising:
an opening and closing member (31) arranged to be capable of contacting a portion of said first antenna (2) and switching between open and closed positions as said first antenna (2) moves; and
a detection member (34) detecting the open and closed positions of said opening and closing member (31).

12. The antenna switching device according to claim 11, wherein said first antenna (2) has a portion contacting said opening and closing member (31) and provided with a protrusion (29) for pressing said opening and closing member (31).

13. Mobile equipment in a form of mobile equipment (1) having a plurality of antennas, comprising the antenna switching device (30) as recited in claim 11.
